(19) United States
(12) Patent Application Publication
(10) Pub. No.: US 2026/0035545 A1
(43) Pub. Date: Feb. 5, 2026

(54) URETHANE FOAM MOLDED BODY

(71) Applicant: Sumitomo Riko Company Limited, Aichi (JP)

(72) Inventors: Takahisa Kose, Aichi (JP); Junichiro Suzuki, Aichi (JP); Junki Owaki, Aichi (JP); Akinori Sugie, Aichi (JP)

(73) Assignee: Sumitomo Riko Company Limited, Aichi (JP)

(21) Appl. No.: 19/352,391

(22) Filed: Oct. 7, 2025

Related U.S. Application Data
(63) Continuation of application No. PCT/JP2024/011361, filed on Mar. 22, 2024.

(30) Foreign Application Priority Data
Jun. 30, 2023 (JP) 2023-108065

(51) Int. Cl. C08K 9/08; C08J 9/00; C08L 75/04; H01F 1/01

(52) U.S. Cl. CPC C08K 9/08; C08J 9/009; C08L 75/04; C08J 2375/04; C08J 2403/02; C08K 2201/001; C08K 2201/01; C08L 2203/14; H01F 1/01

(57) ABSTRACT

A urethane foam molded body includes a base material composed of polyurethane foam, a composite particle oriented and contained in the base material, and a first insulating inorganic particle dispersed in the base material. The composite particle includes a thermally conductive particle, and a magnetic particle adhered to a surface of the thermally conductive particle by a binder. The thermally conductive particle includes an expanded graphite particle, and an amount of an alkali metal ion contained in the expanded graphite particle is 500 ppm or higher and 2,000 ppm or lower.

### CROSS-REFERENCE TO RELATED APPLICATION

This application is a continuation of PCT International Application No. PCT/JP2024/011361, filed on Mar. 22, 2024, which claims priority under 35 U.S.C § 119(a) to Japanese Patent Application No. 2023-108065, filed on Jun. 30, 2023. Each of the above application(s) is hereby expressly incorporated by reference, in its entirety, into the present application.

### BACKGROUND

### Technical Field

The disclosure relates to a urethane foam molded body with high thermal conductivity.

### Related Art

In vehicles such as automobiles, measures are taken to reduce noise generated from engines, transmissions, etc. to reduce noise leaking outside the vehicle or into the passenger compartment. In electric vehicles (EV) and hybrid electric vehicles (HEV), driving sounds from electric powertrains including inverters, motors, gearboxes, etc. are also targets for reduction. As a noise countermeasure, for example, soundproofing materials composed of foam such as polyurethane foam are used. Foam has a low thermal conductivity coefficient because it has numerous cells (bubbles) inside. Thus, in the case of placing it around a noise source that generates heat, there is a risk of malfunction due to heat accumulation.

From the perspective of improving heat dissipation of soundproofing materials using foam, for example, Patent Document 1 describes a urethane foam molded body in which composite particles, which are a composite of thermally conductive particles such as expanded graphite, magnetic particles, and insulating inorganic particles, are oriented and arranged in polyurethane foam, and a heat transmission path is formed in the direction of the orientation, thereby improving heat dissipation properties. In addition, the same document describes that electrical insulation may be imparted by dispersing insulating inorganic particles separately from the composite particles in the polyurethane foam, and that heat dissipation and flame retardancy can be improved according to the properties of the insulating inorganic particles.

### CITATION LIST

### Patent Document

[Patent Document 1] International Publication No. WO2013/042611

However, conventional urethane foam molded bodies have an issue of low heat resistance, specifically, the issue that physical properties such as elongation deteriorate when placed under high temperatures of around 150° C. With low heat resistance, it is difficult to apply them to components that reach high temperatures, such as various ECUs (Electronic Control Units) and junction boxes mounted in vehicles. In the above Patent Document 1, only the thermal conductivity and electrical insulation of the urethane foam molded body are evaluated, and heat resistance is not considered.

The disclosure has been made in view of such circumstances and aims to provide a urethane foam molded body that excels in thermal conductivity and heat resistance.

### SUMMARY

A urethane foam molded body of the disclosure includes a base material composed of polyurethane foam, composite particles oriented and contained in the base material, and first insulating inorganic particles dispersed in the base material. The composite particles include thermally conductive particles and magnetic particles adhered to a surface of the thermally conductive particles by a binder. The thermally conductive particles include expanded graphite particles, and an amount of alkali metal ions contained in the expanded graphite particles is 500 ppm or higher and 2,000 ppm or lower.

### DESCRIPTION OF THE EMBODIMENTS

(1) To solve the above issue, a urethane foam molded body of the disclosure includes a base material composed of polyurethane foam, composite particles oriented and contained in the base material, and first insulating inorganic particles dispersed in the base material. The composite particles include thermally conductive particles and magnetic particles adhered to a surface of the thermally conductive particles by a binder. The thermally conductive particles include expanded graphite particles, and an amount of alkali metal ions contained in the expanded graphite particles is 500 ppm or higher and 2,000 ppm or lower.

The urethane foam molded body of the disclosure includes composite particles oriented in the base material and first insulating inorganic particles dispersed in the base material. By having the composite particles with thermally conductive particles as cores connected in a beaded chain formation, a heat transmission path is formed in the base material. This enables the achievement of desired thermal conductivity. The thermally conductive particles include expanded graphite particles. Expanded graphite particles are produced by inserting substances that generate gas through heating between the layers of flake-shaped graphite. When heat is applied to the expanded graphite particles, the gas generated causes the layers to expand, and stable layers against heat and chemicals are formed. These stable layers become insulation layers and prevent heat transfer. This imparts flame retardancy to the urethane foam molded body. The first insulating inorganic particles are particles of inorganic materials with insulating properties. The presence of the first insulating inorganic particles makes it difficult for the composite particles to conduct electricity between them, imparting electrical insulation to the urethane foam molded body. In addition, in the case where the thermal conductivity coefficient of the first insulating inorganic particles is relatively large, a heat transmission path through the first insulating inorganic particles is formed in addition to the heat transmission path through the composite particles. This further improves the thermal conductivity of the urethane foam molded body. Furthermore, in the case where the first insulating inorganic particles have flame retardancy, the flame retardancy of the urethane foam molded body is improved.

The inventors of the disclosure focused on the expanded graphite particles that constitute the composite particles to solve the heat resistance issue in urethane foam molded bodies. After extensive research, they discovered that the amount of alkali metal ions contained in the expanded graphite particles was one factor causing the decrease in heat resistance of the urethane foam molded body. In general, expanded graphite is produced by oxidizing graphite with sulfuric acid and oxidizing agents, and then neutralizing the acidic substances attached to the surface with neutralizing agents. Since alkali metal compounds, ammonia, etc. are used as neutralizing agents, if these neutralizing agents remain on the surface of the expanded graphite, they react with water contained in the polyurethane foam base material to create an alkaline atmosphere. It is presumed that in this state, when exposed to high temperature, hydrolysis of polyurethane is accelerated and deterioration progresses. In addition, in an alkaline atmosphere, there is a risk that the first insulating inorganic particles may dissolve.

Thus, the amount of alkali metal ions contained in the expanded graphite particles was limited to 500 ppm or higher and 2,000 ppm or lower. By limiting the amount of alkali metal ions to 2,000 ppm or lower, it is possible to suppress the polyurethane foam from becoming excessively alkaline. This suppresses hydrolysis of polyurethane and makes the first insulating inorganic particles less likely to dissolve. As a result, even in the case where the urethane foam molded body is placed under high temperature, it is possible to suppress the deterioration of polyurethane and suppress the decrease in physical properties such as elongation. On the other hand, due to the influence of interlayer compounds in the expanded graphite particles, the raw materials for producing the urethane foam molded body may tend to become acidic, which could affect the foaming and curing reaction. Thus, by maintaining the amount of alkali metal ions at 500 ppm or higher, the pH balance of the raw materials may be maintained, minimizing the influence on moldability. Based on the above, the urethane foam molded body of the disclosure excels in thermal conductivity and heat resistance.

(2) In the above configuration, the alkali metal ions may include sodium ions. Sodium ions are contained in hydroxides, oxides, etc. used as neutralizing agents and have a significant influence on pH. Thus, by limiting this amount, it becomes easier to optimize the pH of the polyurethane foam.

(3) In any of the above configurations, the content of the composite particles may be 5% by volume or more and 50% by volume or less in a case where the volume of the urethane foam molded body is 100% by volume. According to this configuration, it is possible to obtain effects such as improved thermal conductivity due to the composite particles while minimizing the influence on the foaming and curing reaction and moldability.

(4) In any of the above configurations, the content of the first insulating inorganic particles may be 5% by volume or more and 20% by volume or less in a case where the volume of the urethane foam molded body is 100% by volume. According to this configuration, it is possible to obtain effects such as imparting electrical insulation and improving thermal conductivity due to the first insulating inorganic particles while minimizing the influence on the foaming and curing reaction and moldability.

(5) In any of the above configurations, the thermal conductivity coefficient of the first insulating inorganic particles may be 5 W/m·K or higher. According to this configuration, it is possible to obtain effects of improved thermal conductivity due to the first insulating inorganic particles.

(6) In any of the above configurations, the first insulating inorganic particles may include at least one selected from aluminum hydroxide, aluminum oxide, aluminum nitride, magnesium hydroxide, magnesium oxide, talc, calcium carbonate, clay, mica, and silica. The first insulating inorganic particles of this configuration are relatively inexpensive and easily available. Among these, aluminum hydroxide, aluminum oxide, aluminum nitride, magnesium hydroxide, magnesium oxide, and talc are suitable for enhancing the thermal conductivity of the urethane foam molded body because they have relatively high thermal conductivity coefficients.

(7) In any of the above configurations, the composite particles may include second insulating inorganic particles adhered to a surface of the thermally conductive particles by a binder. In this configuration, the second insulating inorganic particles may be directly adhered to the surface of the thermally conductive particles that form the core, or may be indirectly adhered via magnetic particles. As the magnetic particles, ferromagnetic materials such as stainless steel and iron are used. Thus, the composite particles, which are composites of thermally conductive particles and magnetic particles, have high electrical conductivity. When second insulating inorganic particles are adhered to composite particles in this state, even if the composite particles are oriented in contact with each other, it becomes difficult for the thermally conductive particles or magnetic particles (electrically conductive particles) to contact each other between adjacent composite particles. Thus, the electrical resistance between composite particles increases. In addition, by having composite particles contact each other through the second insulating inorganic particles, it is possible to cut off conduction between composite particles. As a result, in the urethane foam molded body of this disclosure, desired electrical insulation can be achieved. Thus, according to this configuration, in addition to high thermal conductivity and heat resistance, electrical insulation may also be imparted. Thus, the urethane foam molded body of this configuration is also suitable for applications that require both heat dissipation and electrical insulation, such as heat dissipation components in electronic devices.

(8) In the configuration of (7) above, the second insulating inorganic particles may include at least one selected from aluminum hydroxide, aluminum oxide, aluminum nitride, magnesium hydroxide, magnesium oxide, talc, calcium carbonate, clay, mica, and silica. As described in the configuration of (6) above, the second insulating inorganic particles of this configuration are relatively inexpensive and easily available. Among these, talc and mica exhibit a flaky shape and excel in coverage. In addition, aluminum hydroxide, aluminum oxide, aluminum nitride, magnesium hydroxide, magnesium oxide, and talc are less likely to hinder thermal conductivity between composite particles because they have relatively high thermal conductivity coefficients.

In the base material of the urethane foam molded body of this disclosure, composite particles with thermally conductive particles as the core are oriented, and first insulating inorganic particles are dispersed. The thermally conductive particles include expanded graphite particles, and the amount of alkali metal ions contained in the expanded graphite particles is 500 ppm or higher and 2,000 ppm or lower. As a result, the pH of the polyurethane foam is adjusted to a desired range, and even if the urethane foam molded body is placed under high temperature, the deterioration of polyurethane is suppressed, and the reduction of physical properties such as elongation can be suppressed. Thus, the urethane foam molded body of this disclosure excels in thermal conductivity and heat resistance.

The following describes embodiments of the urethane foam molded body of this disclosure. The embodiments are not limited to the following forms, and may be implemented in various modification examples and improved forms that may be carried out by those skilled in the art.

### <Urethane Foam Molded Body>

The urethane foam molded body of this disclosure includes a base material composed of polyurethane foam, composite particles that are oriented and contained in the base material, and first insulating inorganic particles that are dispersed in the base material.

### [Base Material]

The polyurethane foam of the base material is produced from foamed urethane resin raw materials such as polyisocyanate components and polyol components. The foamed urethane resin raw materials may be prepared from already known raw materials such as polyols and polyisocyanates. As polyols, appropriate selections may be made from polyhydroxy compounds, polyether polyols, polyester polyols, polymer polyols, polyether polyamines, polyester polyamines, alkylene polyols, urea dispersion polyols, melamine-modified polyols, polycarbonate polyols, acrylic polyols, polybutadiene polyols, phenol-modified polyols, and the like. In addition, as polyisocyanates, appropriate selections may be made from tolylene diisocyanate, phenylene diisocyanate, xylylene diisocyanate, diphenylmethane diisocyanate, triphenylmethane triisocyanate, polymethylene polyphenyl isocyanate, naphthalene diisocyanate, and derivatives thereof (for example, prepolymers obtained by reaction with polyols, modified polyisocyanates), and the like.

The foamed urethane resin raw materials may further appropriately contain catalysts, foaming agents, foam stabilizers, plasticizers, crosslinking agents, chain extenders, flame retardants, antistatic agents, viscosity reducers, stabilizers, fillers, colorants, and the like. For example, as catalysts, amine-based catalysts such as tetraethylenediamine, triethylenediamine, dimethylethanolamine, and organometallic catalysts such as tin laurate and tin octanoate may be mentioned. As foaming agents, water is suitable. Besides water, methylene chloride, freons, CO₂ gas, and the like may be mentioned. In addition, silicone-based foam stabilizers are suitable as foam stabilizers, and triethanolamine, diethanolamine, and the like are suitable as crosslinking agents.

The shape, size, etc. of the base material are not particularly limited and may be appropriately determined according to the application. The composite particles contained in the base material may be arranged with a certain regularity. For example, they may be arranged in a straight line or in a curved line between one end and the other end of the urethane foam molded body (not necessarily at an end 180° opposite to the one end). In addition, they may be arranged radially from the center toward the periphery.

### [Composite Particles]

The composite particles that are oriented and contained in the base material are particles in which magnetic particles and the like are adhered to the surface of thermally conductive particles that serve as a core by a binder. The thermally conductive particles are non-magnetic materials with relatively high thermal conductivity coefficient. In this specification, diamagnetic material and paramagnetic material other than ferromagnetic materials and antiferromagnetic materials are referred to as non-magnetic materials. The thermally conductive particles include expanded graphite particles. The thermally conductive particles may be single particles or aggregate particles in which multiple particles are integrated. Examples of composite particles include particles in which magnetic particles and the like are adhered to the surface of expanded graphite particles, and particles in which magnetic particles and the like are adhered to the surface of aggregate particles formed by integrating expanded graphite particles with other particles. In addition, the composite particles may include particles in which magnetic particles and the like are adhered to the surface of particles other than expanded graphite particles.

Normally, urethane foam molded bodies that have been imparted with flame retardancy possess a dropping action that suppresses the spread of fire by dropping burning material when exposed to flames. However, when magnetic particles are blended, the dropping action may be impaired, potentially reducing the self-extinguishing properties of the urethane foam molded body. In the urethane foam molded body of the disclosure, the composite particles are oriented. As a result, heat applied to the urethane foam molded body is easily transmitted to the thermally conductive particles, allowing the expanded graphite particles to quickly reach the expansion start temperature. This enables the flame-retardant effects of the expanded graphite particles to be exerted promptly. Thus, according to this configuration, it is possible to suppress the reduction in self-extinguishing properties of the urethane foam molded body and maintain flame retardancy.

For expanded graphite particles, appropriate selection may be made considering factors such as expansion start temperature and expansion rate. Since the expansion start temperature must be higher than the heat generation temperature during the molding of the urethane foam molded body, expanded graphite particles with an expansion start temperature of 150° C. or higher are suitable. The amount of alkali metal ions contained in the expanded graphite particles is 500 ppm or higher and 2,000 ppm or lower. By keeping the amount of alkali metal ions at 2,000 ppm or lower, it is possible to suppress the polyurethane foam from becoming excessively alkaline. On the other hand, by maintaining the amount of alkali metal ions at 500 ppm or higher, a pH balance can be achieved with the interlayer compounds in the raw materials for producing the urethane foam molded body, thereby minimizing the influence on moldability.

Alkali metal ions include lithium ions, sodium ions, potassium ions, etc. In the producing process of expanded graphite, neutralizing agents such as sodium hydroxide and sodium oxide are often used. Thus, by limiting the amount of sodium ions, it is easier to optimize the pH of the polyurethane foam. The amount of alkali metal ions contained in the expanded graphite particles may be determined by analyzing a liquid sample obtained by immersing 2 g of expanded graphite particle powder in 50 mL of ion-exchanged water at 50° C. for 2 hours, using ICP (high frequency Inductively Coupled Plasma) emission spectroscopy. In addition, it is desirable that the pH of a dispersion liquid in which 2 g of expanded graphite particle powder is dispersed in 50 mL of ion-exchanged water at room temperature (20° C.±5° C., same hereinafter) be 6 or higher and 8 or less.

For thermally conductive particles other than expanded graphite particles, it is preferable to use particles with a thermal conductivity coefficient of 200 W/m·K or higher. Examples include carbon materials such as natural graphite, artificial graphite, carbon fiber, as well as aluminum, gold, silver, copper, and alloys based on these materials.

The shape of the thermally conductive particles is not particularly limited as long as they may be composited with other particles such as magnetic particles. For example, various shapes may be adopted, such as flake-like, fibrous, columnar, spherical, ellipsoidal, oblong spherical (a shape in which a pair of opposing hemispheres are connected by a cylinder), etc. When the thermally conductive particles have a shape other than spherical, the contact area between composite particles increases. This makes it easier to secure heat transmission path and also increases the amount of heat transferred.

From the viewpoint of increasing thermal conductivity coefficient, it is desirable that the median diameter of the thermally conductive particles be 100 μm or more. It is more suitable if it is 700 μm or more. On the other hand, if the thermally conductive particles are too large, there is a risk cracks may occur from them, making the molded body brittle. Thus, it is desirable that the median diameter of the thermally conductive particles be 3,000 μm or less. It is more suitable if it is 2,000 μm or less. In this specification, unless specifically stated otherwise, the median diameter is a value (D₅₀) obtained from the volume-based particle size distribution measured by laser diffraction/scattering method. For commercially available products, catalog values may be adopted.

As long as the magnetic particles can orient the composite particles, for example, ferromagnetic materials such as iron, nickel, cobalt, gadolinium, stainless steel, magnetite, maghemite, manganese zinc ferrite, barium ferrite, strontium ferrite, antiferromagnetic materials such as MnO, Cr₂O₃, FeCl₂, MnAs, and particles of alloys using these materials are suitable. Among these, iron, nickel, cobalt, and their iron-based alloys (including stainless steel) are suitable from the viewpoint of being easily available as fine particles and having high saturation magnetization. Iron in particular is relatively inexpensive and easily available, therefore suitable for reducing producing costs and mass production.

The magnetic particles may be directly adhered to the surface of the thermally conductive particles, or may be indirectly adhered via second insulating inorganic particles described later. In addition, the magnetic particles may be adhered to only a part of the surface of the thermally conductive particles, or may be adhered so as to cover the entire surface. The size of the magnetic particles may be appropriately determined in consideration of the size of the thermally conductive particles, the orientation of the composite particles, and the thermal conductivity between composite particles. For example, it is desirable that the particle diameter of the magnetic particles be 1/10 or less of the particle diameter of the thermally conductive particles. The “particle diameter” in this case refers to the equivalent spherical diameter of equal volume. As the size of the magnetic particles decreases, the saturation magnetization of the magnetic particles tends to decrease. Thus, in order to orient the composite particles with a smaller amount of magnetic particles, it is desirable that the median diameter of the magnetic particles be 100 nm or more. It is suitable if it is 1 μm or more, and even more suitable if it is 5 μm or more.

The shape of the magnetic particles is not particularly limited. For example, in the case where the shape of the magnetic particles is flat, the distance between adjacent thermally conductive particles becomes shorter compared to the case where they are spherical. This improves the thermal conductivity between adjacent composite particles. As a result, the thermal conductivity of the urethane foam molded body is improved. In addition, in the case where the shape of the magnetic particles is flat, the magnetic particles and the thermally conductive particles contact each other on a plane. That is, the contact area between the two increases. This improves the adhesion between the magnetic particles and the thermally conductive particles. Thus, the magnetic particles become less likely to detach. In addition, the thermal conductivity between the magnetic particles and the thermally conductive particles is also improved. For these reasons, it is desirable to adopt flake-shaped particles as the magnetic particles.

From the viewpoint of being able to orient the composite particles even in a relatively low magnetic field, the content of the magnetic particles is desirably 20 mass % or more, where the mass of the thermally conductive particles in the base material is 100 mass %. In addition, from the viewpoint of cost reduction and weight reduction, it is desirable that the content of the magnetic particles be 130 mass % or less. It is suitable if it is 100 mass % or less, and even more suitable if it is 80 mass % or less.

The binder for adhering the thermally conductive particles and the magnetic particles may be appropriately selected in consideration of adherence, influence on the foaming and curing reaction, and so on. Water-soluble polymers are suitable because they have little influence on the foaming and curing reaction and are environmentally friendly. For example, methyl cellulose, carboxymethyl cellulose, hydroxypropyl methyl cellulose, polyvinyl alcohol, starch, and the like may be mentioned. Among these, starch is suitable because it is relatively inexpensive and has high adhesiveness and excellent granulation properties.

The thermally conductive particles and the magnetic particles have electrical conductivity. Thus, when the composite particles are aligned and oriented, a conduction path is formed in the base material. For example, the composite particles may be constituted by adhering second insulating inorganic particles to the surface of the thermally conductive particles in addition to the magnetic particles using a binder. By doing so, even when the composite particles are oriented, the electrical resistance between adjacent composite particles may be increased or the conduction may be blocked. As a result, electrical insulation may be imparted to the urethane foam molded body.

The second insulating inorganic particles, similar to the first insulating inorganic particles dispersed in the base material, may be any particles of inorganic material having insulating properties. Examples of the second insulating inorganic materials include aluminum hydroxide, aluminum oxide, aluminum nitride, magnesium hydroxide, magnesium oxide, talc, calcium carbonate, clay, mica, silica, and the like. One type of these may be used alone, or two or more types may be used in combination. Among these, talc and mica are suitable because they exhibit a flaky shape and have excellent coverage. In addition, from the viewpoint of not hindering the thermal conductivity between composite particles, materials with relatively high thermal conductivity coefficient may be adopted.

The second insulating inorganic particles may be directly adhered to the surface of the thermally conductive particles, or may be indirectly adhered via magnetic particles or the like. In addition, the second insulating inorganic particles may be adhered to only a portion of the surface of the thermally conductive particles, or may be adhered to cover the entire surface. When the entire surface of the thermally conductive particles is covered with the second insulating inorganic particles, it is suitable because the influence of interlayer substances in the expanded graphite particles or remaining alkali metal ions is reduced. From the viewpoint of increasing the electrical resistance between composite particles and enhancing the electrical insulation of the urethane foam molded body, it is desirable that the second insulating inorganic particles be arranged in the outermost layer of the composite particles. The binder for adhering the magnetic particles to the thermally conductive particles and the binder for adhering the insulating inorganic particles may be the same or different.

The size of the second insulating inorganic particles may be appropriately determined in consideration of the adherence to the thermally conductive particles and magnetic particles, as well as the electrical insulation and thermal conductivity between composite particles. If the second insulating inorganic particles are too large, the adherence and thermal conductivity between composite particles decrease. For example, it is desirable that the particle diameter of the second insulating inorganic particles be 1/10 or less of the particle diameter of the thermally conductive particles. The “particle diameter” in this case refers to the equivalent spherical diameter of equal volume. In addition, the second insulating inorganic particles are adhered to the thermally conductive particles and are only a part of the composite particles. Thus, unlike the first insulating inorganic particles described later, the contact area with the polyurethane foam of the base material is small, and the influence on the polyurethane foam is small. Thus, the median diameter of the second insulating inorganic particles may be 1 μm or more and 20 μm or less.

The shape of the second insulating inorganic particles is not particularly limited. For example, in the case where the shape of the second insulating inorganic particles is flat, the distance between adjacent thermally conductive particles may be shortened compared to the case where they are spherical. Thus, it is less likely to hinder the thermal conductivity between adjacent composite particles. In addition, as the contact area with the thermally conductive particles increases, the second insulating inorganic particles become less likely to peel off.

The content of the composite particles may be determined in consideration of the thermal conductivity, the influence on the foaming and curing reaction of the polyurethane foam, moldability, and so on. To achieve the desired thermal conductivity, it is desirable that the content of the composite particles be 5% by volume or more when the volume of the urethane foam molded body is 100% by volume, and more suitably 10% by volume or more. On the other hand, from the viewpoint of not hindering the foaming and curing reaction and ensuring good moldability, it is desirable that the content of the composite particles be 50% by volume or less, and more suitably 20% by volume or less.

### [First Insulating Inorganic Particles]

The type of first insulating inorganic particles dispersed in the base material may be the same as or different from the second insulating inorganic particles added as constituent particles of the composite particles. The shape of the first insulating inorganic particles is not particularly limited, and may be spherical or flaky. The first insulating inorganic particles may be of one type or two or more types. For the first insulating inorganic particles, the aforementioned aluminum hydroxide, aluminum oxide, aluminum nitride, magnesium hydroxide, magnesium oxide, talc, calcium carbonate, clay, mica, silica, etc. are also suitable. In addition, from the viewpoint of increasing the thermal conductivity of the urethane foam molded body, those with relatively large thermal conductivity coefficient are desirable. For example, it is suitable that the thermal conductivity coefficient of the first insulating inorganic particles is 5 W/m·K or higher. Among these, aluminum hydroxide is suitable because it also has flame retardancy.

The size of the first insulating inorganic particles may be appropriately determined in consideration of the electrical insulation, thermal conductivity, moldability, etc. of the urethane foam molded body. In the case where the contact area between the first insulating inorganic particles and the polyurethane foam is large, there is a concern that the heat resistance of the urethane foam molded body may decrease due to the influence of the first insulating inorganic particles. For example, in the case where the first insulating inorganic particles are particles that show alkalinity by reacting with water, they react with water contained in the polyurethane foam to generate an alkaline atmosphere. It is presumed that in this state, when exposed to high temperature, hydrolysis of polyurethane is accelerated and deterioration progresses. Thus, from the viewpoint of minimizing the influence on the polyurethane foam, it is desirable that the first insulating inorganic particles include large diameter particles with a median diameter of 55 μm or more and 200 μm or less. In the case where the median diameter is 55 μm or more, the contact area with the polyurethane foam becomes smaller, and the influence on the polyurethane foam becomes smaller. For example, in the case where the large diameter particles are particles that show alkalinity by reacting with water (alkaline inorganic particles), deterioration due to hydrolysis of polyurethane is suppressed, and even if the urethane foam molded body is placed under high temperature, physical properties such as elongation are less likely to decrease. In this specification, “particles that show alkalinity by reacting with water” refers to particles for which the pH becomes greater than 7 when measuring the pH of a dispersion liquid in which 2 g of the target particle powder is dispersed in 50 mL of ion-exchanged water at room temperature. On the other hand, in the case where the median diameter is 200 μm or less, the influence on moldability is small, and the occurrence of cracks and the like is suppressed. From the viewpoint of further improving moldability and normal state physical properties, it is preferable that the median diameter of the large diameter particles is 150 μm or less. The first insulating inorganic particles may be composed only of large diameter particles, or may include particles other than large diameter particles if the desired heat resistance and moldability can be achieved.

The content of the first insulating inorganic particles, considering the influence on the foaming and curing reaction of the polyurethane foam and moldability, is desirably 20% by volume or less when the volume of the urethane foam molded body is 100% by volume, and more suitably 15% by volume or less. In addition, to obtain the desired effects such as imparting electrical insulation and improving thermal conductivity, it is desirably 5% by volume or more, and more suitably 8% by volume or more.

### <Producing Method of Urethane Foam Molded Body>

The producing method of urethane foam molded body of the disclosure is not particularly limited. As one suitable embodiment of the producing method, the producing method of urethane foam molded body of the disclosure includes a composite particle producing step, a raw material mixture producing step, and a foam molding step. Each step is described below.

### [Composite Particle Producing Step]

This step is a step of producing composite particles by stirring granulation raw materials containing powder of thermally conductive particles, powder of magnetic particles, powder of second insulating inorganic particles which are blended as needed, a binder, and water. The blending amount of the powder and binder to be used may be appropriately adjusted considering the magnetic field orientation of the composite particles, electrical insulation, thermal conductivity, etc. of the urethane foam molded body.

The blending amount of the powder of magnetic particles, considering the magnetic field orientation of the composite particles, is desirably 20 parts by mass or more with respect to 100 parts by mass of the powder of thermally conductive particles. On the other hand, considering cost and weight reduction, it is desirably 130 parts by mass or less, and more suitably 100 parts by mass or less, and even more suitably 80 parts by mass or less. As a sufficient amount necessary for adhesion of particles, the blending amount of the binder is desirably 2 mass % or more when the total mass of the powder to be adhered is 100 mass %. On the other hand, if the binder becomes excessive, there is a risk that the composite particles may aggregate with each other. Thus, the blending amount of the binder is desirably 10 mass % or less, and more suitably 5 mass % or less. The binder may be solid or liquid. In the case of using a water-soluble powder as the binder, it is preferable to previously stirring the binder and other powder raw materials and then and water. By doing so, aggregation of particles can be suppressed.

In the case of including the powder of second insulating inorganic particles in the granulation raw materials and arranging the second insulating inorganic particles in the outermost layer of the composite particles, this step may include a first stirring step of stirring a first raw material containing powder of thermally conductive particles, powder of magnetic particles, a binder, and water, and a second stirring step of adding the powder of second insulating inorganic particles to the stirred first raw material and further stirring it.

### [Raw Material Mixture Producing Step]

This step is a step of producing raw material mixture by mixing the powder of composite particles produced in the previous step, the powder of first insulating inorganic particles, and foamed urethane resin raw material.

For the foamed urethane resin raw material, as mentioned earlier, it may be prepared from raw materials such as polyol, polyisocyanate, catalyst, foaming agent, foam stabilizer, etc. The raw material mixture may be produced, for example, by mechanically stirring the powder of composite particles, the powder of first insulating inorganic particles, and the foamed urethane resin raw material using a stirring blade or the like. Alternatively, it may also be produced by adding the powder of composite particles and the powder of first insulating inorganic particles to at least one of the two components of the foamed urethane resin raw material (polyol raw material, polyisocyanate raw material), preparing two types of raw materials, and then mixing both raw materials.

### [Foam Molding Step]

This step is a step of injecting the raw material mixture produced in the previous step into a cavity of a foam mold, and performing foam molding while applying a magnetic field so that the magnetic flux density in the cavity becomes substantially uniform.

The magnetic field may be formed in a direction that orients the composite particles. For example, in the case of orienting the composite particles in a straight line, it is desirable to form the magnetic force lines in the cavity of the foam mold to be substantially parallel from one end of the cavity toward the other end. To form such a magnetic field, magnets may be placed near both sides of one end and the other end of the foam mold so as to sandwich the foam mold. The magnets may be permanent magnets or electromagnets. Using electromagnets allows for instantaneous switching between on and off of the magnetic field formation, and easy control of the magnetic field strength. Thus, it is easier to control the foam molding. In addition, it is desirable that the magnetic force lines constituting the magnetic field form a closed loop. By doing so, leakage of magnetic force lines is suppressed, and a stable magnetic field may be formed in the cavity.

In this step, the magnetic field is formed so that the magnetic flux density in the cavity becomes substantially uniform. For example, it is preferable that the difference in magnetic flux density within the cavity is within ±10%. It is more suitable if it is within ±5%, and even more preferably within ±3%. By forming a uniform magnetic field in the cavity of the foam mold, the uneven distribution of composite particles can be suppressed, and the desired orientation state can be obtained. In addition, it is preferable to perform the foam molding at a magnetic flux density of 150 mT or higher and 350 mT or lower. By doing so, the composite particles in the raw material mixture may be reliably oriented. It is desirable that the magnetic field is applied while the viscosity of the foamed urethane resin raw material is relatively low. If the magnetic field is applied when the foamed urethane resin raw material has increased in viscosity and the foam molding has been completed to some extent, it becomes difficult to obtain the desired thermal conductivity because the composite particles are difficult to orient. It is not necessary to apply the magnetic field throughout the entire time of foam molding.

After the foam molding is completed in this step, the urethane foam molded body of the disclosure is obtained by demolding. At this time, depending on the method of foam molding, a skin layer may be formed on at least one of one end and the other end of the urethane foam molded body. The skin layer may be removed according to the application (of course, it may also be left unremoved).

### Examples

Next, the disclosure will be described more specifically with Examples. In these Examples, urethane foam molded bodies were produced using powders of expanded graphite particles with different sodium ion content, and their properties were evaluated.

### <Producing of Composite Particles>

Composite particles were produced by stirring granulation raw materials containing expanded graphite powder as thermally conductive particles, stainless steel powder as magnetic particles, starch powder as a binder, talc powder as second insulating inorganic particles, and water. Four types of expanded graphite particle powders with different sodium (Na) ion content, A to D, were used to produce four types of composite particles. First, 1,000 parts by mass of expanded graphite powder, 600 parts by mass of stainless steel powder, and 100 parts by mass of starch powder were added to a container of a high-speed stirring type mixing granulator and mixed by blade stirring, and then 400 parts by mass of water was added and mixed for 1 minute. Next, 400 parts by mass of talc powder was added and mixed for an additional 4 minutes. The stirring speed was 400 rpm. The obtained powder was dried to form a powder of composite particles. The details of the materials used are shown in (a) to (d) below, and the blending amount of each is shown in Table 1 later.

### (a) Thermally Conductive Particles

Expanded graphite powder A: “EXA-50” produced by Fuji Graphite Work Co., Ltd., Na ion content 500 ppm, pH 6, median diameter 300 μm (same for expanded graphite powders B to D).

For the following expanded graphite powders B to D, they were produced by dropping a sodium hydroxide aqueous solution with a concentration of 10 mass % into expanded graphite powder A and drying. The pH of the expanded graphite powder was measured by dispersing 2 g of expanded graphite powder in 50 mL of ion-exchanged water at room temperature, and measuring the pH of the dispersion liquid after 5 minutes using a glass electrode pH meter.

Expanded graphite powder B: Na ion content 1,000 ppm, pH 7.

Expanded graphite powder C: Na ion content 2,000 ppm, pH 8.

Expanded graphite powder D: Na ion content 3,500 ppm, pH 10.

### (b) Magnetic Particles

Stainless steel powder: “AKT” produced by Mitsubishi Steel Mfg. Co., Ltd., median diameter 8.5-13.0 μm.

### (c) Binder

Starch powder: “Instant Tender Jel C” produced by Nihon Cornstarch Co., Ltd.

### (d) Second Insulating Inorganic Particles

Talc powder: “Micro Ace (registered trademark) K-1” produced by Nippon Talc Co., Ltd., median diameter 8 μm.

### <Producing of Urethane Foam Molded Body>

A urethane foam molded body was produced using the powder of the produced composite particles and aluminum hydroxide powder as the first insulating inorganic particles. First, 100 parts by mass of polyether polyol (produced by Sumika Covestro Urethane Co., Ltd., “SBU (registered trademark) Polyol 0248”), 2 parts by mass of diethylene glycol as a chain extender (produced by Mitsubishi Chemical Corporation), 2 parts by mass of water as a foaming agent, 1.5 parts by mass of tetraethylenediamine-based catalyst (produced by Kao Corporation, “Kaolizer (registered trademark) No. 31”), and 0.5 parts by mass of silicone-based foam stabilizer (produced by Dow Corning Toray Co., Ltd., “SZ-1333”) were mixed to prepare the polyol raw material. In addition, a modified diphenylmethane diisocyanate (MDI) was prepared as the polyisocyanate raw material. The modified MDI was produced by mixing polyether polyol (same as above) and 4,4′-diphenylmethane diisocyanate (produced by Tosoh Corporation, “Millionate MT”) to achieve an isocyanate (NCO) content of 70 mass %, and reacting at 100° C. for 180 minutes under nitrogen purge. Next, 80 parts by mass of the composite particle powder and 60 parts by mass of aluminum hydroxide powder (produced by Nippon Light Metal Co., Ltd., “SB53”, median diameter 55 μm, thermal conductivity coefficient 8 W/m·K) were added and mixed with 100 parts by mass of the polyol raw material to prepare a premix polyol. Subsequently, 100 parts by mass of the premix polyol and 10 parts by mass of the polyisocyanate raw material (modified MDI) were mixed to form the raw material mixture. The pH of the dispersion liquid was measured using a glass electrode pH meter 5 minutes after dispersing 2 g of aluminum hydroxide powder in 50 mL of ion-exchanged water at room temperature, and the pH was 8.

Then, the raw material mixture were injected into an aluminum foam mold (cavity dimensions: 130 mm length×130 mm width×5 mm thickness rectangular parallelepiped), and the foam mold was sealed. The foam mold was then placed in a magnetic induction foam molding apparatus to perform foam molding. A uniform magnetic field was formed in the cavity of the foam mold with substantially parallel magnetic force lines directed from top to bottom. The magnetic flux density in the cavity was 200 mT, with the difference in magnetic flux density within the cavity being within ±3%. The foam molding was performed with the magnetic field applied for the first 2 minutes, followed by approximately 5 minutes without the magnetic field. After the foam molding was completed, the urethane foam molded body was obtained by demolding. The obtained urethane foam molded bodies were designated as urethane foam molded bodies A to D corresponding to the types of expanded graphite particles powder used. The content of composite particles in urethane foam molded bodies A to D was 7.5% by volume, and the content of the first insulating inorganic particles was 12.5% by volume (with the volume of the urethane foam molded body being 100% by volume in both cases). Urethane foam molded bodies A, B, and C are included in the concept of the urethane foam molded body of the disclosure.

### <Evaluation of Urethane Foam Molded Body>

The thermal conductivity, elongation, heat resistance, moldability, and flame retardancy of the produced urethane foam molded bodies were evaluated. The evaluation results are summarized in Table 1 below. The evaluation methods are as follows.

### [Thermal Conductivity]

The thermal conductivity coefficient of the urethane foam molded body was measured using “HC-110” produced by EKO Instruments Co., Ltd. in accordance with the heat flow meter method of JIS A1412-2:1999.

### [Elongation]

Five dumbbell-shaped No. 1 test specimens as specified in JIS K 6251:2017 were prepared from the urethane foam molded body, and tensile tests as specified in the same JIS were conducted on each test specimen at a tensile speed of 200 mm/min to calculate the elongation at break (Eb). Moreover, in the case where the elongation at break of all test specimens was 50% or higher, the normal state physical properties were evaluated as extremely good; if even one, but not all, test specimen had an elongation at break of 50% or higher, the normal state physical properties were evaluated as good; and if all test specimens had an elongation at break of less than 50%, the normal state physical properties were evaluated as poor.

### [Heat Resistance]

Dumbbell-shaped No. 1 test specimens were prepared in the same manner as in the elongation evaluation described above, and they were placed in an oven temperature-controlled at 150° C. and held for 400 hours. After returning the test specimens to room temperature, tensile tests were conducted under the same conditions as in the elongation evaluation described above, and the elongation at break (Eb) was calculated. Moreover, in the case where the elongation at break of all test specimens was 30% or higher, the heat resistance was evaluated as extremely good; in if even one, but not all, test specimen had an elongation at break of 30% or higher, the heat resistance was evaluated as good; and if all test specimens had an elongation at break of less than 30%, the heat resistance was evaluated as poor.

### [Moldability]

After demolding following foam molding, it was visually observed whether the urethane foam molded body was deformed or not. Moreover, in the case where no deformation was observed in the appearance, the moldability was evaluated as extremely good; in the case where small deformations were observed in part of the appearance, the moldability was evaluated as good; and in the case where the appearance was significantly deformed, the moldability was evaluated as poor.

### [Flame Retardancy]

A vertical burning test according to UL94 standard was conducted. In the vertical burning test, a gas burner flame is applied to the lower end of a vertically held sample for 10 seconds. If the combustion stops within 30 seconds, the flame is applied again for 10 seconds. Moreover, the flame retardancy is determined to be V-O level in the case where all of the following five criteria are satisfied: (1) The sample does not burn for more than 10 seconds in either of the two flame applications. (2) The total burning time for each of the two flame applications to five samples does not exceed 50 seconds. (3) No sample burns up to the position of the fixing clamp. (4) No sample drips burning particles that ignite the cotton placed below the sample. (5) No sample remains red hot for more than 30 seconds after the second flame application. In addition, it is determined to be V-2 level in the case where all of the following five criteria are satisfied: (1) The sample does not burn for more than 30 seconds in either of the two flame applications. (2) The total burning time for each of the two flame applications to five samples does not exceed 250 seconds. (3) No sample burns up to the position of the fixing clamp. (4) There is dripping of burning particles that ignite the cotton placed below the sample. (5) No sample remains red hot for more than 60 seconds after the second flame application.

TABLE 1

| Urethane foam molded body | | | | A | B | C | D |
|---|---|---|---|---|---|---|---|
| Composite | Thermally | Expanded | A: Na ion | 1,000 | — | — | — |
| particle | conductive | graphite | content 500 | | | | |
| [parts by | particle | powder | ppm, pH 6 | | | | |
| mass] | | | B: Na ion | — | 1,000 | — | — |
| | | | content | | | | |
| | | | 11,000 ppm, | | | | |
| | | | pH 7 | | | | |
| | | | Na ion | — | — | 1,000 | — |
| | | | content | | | | |
| | | | 2,000 ppm, | | | | |
| | | | pH 8 | | | | |
| | | | Na ion | — | — | — | 1,000 |
| | | | content | | | | |
| | | | 3,500 ppm, | | | | |
| | | | pH 10 | | | | |
| | Magnetic | Stainless steel powder | | 600 | 600 | 600 | 600 |
| | particle | | | | | | |
| | Binder | Starch powder | | 100 | 100 | 100 | 100 |
| | Second | Talc powder | | 400 | 400 | 400 | 400 |
| | insulating | | | | | | |
| | inorganic | | | | | | |
| | particle | | | | | | |

| | | | | |
|---|---|---|---|---|
| Water | 400 | 400 | 400 | 400 |

| First insulating inorganic | Aluminum hydroxide | 60 | 60 | 60 | 60 |
|---|---|---|---|---|---|
| particles [parts by mass] | powder (pH 8, median | | | | |
| | diameter 55 μm) | | | | |

| Content of composite particles [% by volume] | | 7.5 | 7.5 | 7.5 | 7.5 |
|---|---|---|---|---|---|
| Content of first insulating inorganic particle [% by | | 12.5 | 12.5 | 12.5 | 12.5 |
| volume] | | | | | |
| Evaluation | Thermal conductivity coefficient | 0.5 | 0.7 | 0.7 | 0.7 |
| results | [W/m · K] | | | | |
| | Normal state physical properties | extremely | extremely | extremely | extremely |
| | (elongation) | good | good | good | good |
| | Heat resistance (elongation after holding | extremely | extremely | good | poor |
| | at 150° C. for 400 hours) | good | good | | |
| | Moldability | good | extremely | extremely | extremely |
| | | | good | good | good |
| | Flame retardancy (UL94 standard) | V-2 | V-0 | V-0 | V-0 |

As shown in Table 1, urethane foam molded bodies A to C include composite particles granulated using expanded graphite powder with a sodium ion content of 500 ppm or higher and 2,000 ppm or lower. Thus, the elongation under normal conditions was good, and the decrease in elongation was small even after being held at high temperature. In addition, the thermal conductivity coefficient of urethane foam molded bodies A to C was large at 0.5 W/m·K or higher. In urethane foam molded body A, the sodium ion content was lower compared to urethane foam molded bodies B and C. As a result, the raw material mixture tended to be acidic, affecting the curing reaction, which is believed to have led to decreased moldability and flame retardancy. In urethane foam molded body C, the sodium ion content was higher compared to urethane foam molded bodies A and B. Thus, the heat resistance slightly decreased. From the above, it was confirmed that urethane foam molded bodies A to C satisfied the requirements for thermal conductivity and heat resistance. In contrast, urethane foam molded body D, which includes composite particles granulated using expanded graphite powder with a high sodium ion content of 3,500 ppm, satisfied the requirements for the thermal conductivity, normal state physical properties, and flame retardancy, but resulted in inferior heat resistance.

### INDUSTRIAL APPLICABILITY

The urethane foam molded body of the disclosure is suitable as a soundproofing material in vehicle parts such as battery covers, electric powertrain (eAxel) covers, seat motor covers, under covers, floor mats, dash silencers, hood silencers, various ECUs, junction boxes, and electronic devices such as personal computers.

What is claimed is:

1. A urethane foam molded body, comprising:
a base material composed of a polyurethane foam, a composite particle oriented and contained in the base material, and a first insulating inorganic particle dispersed in the base material,
wherein the composite particle includes a thermally conductive particle, and a magnetic particle adhered to a surface of the thermally conductive particle by a binder, and
the thermally conductive particle includes an expanded graphite particle, and an amount of an alkali metal ion contained in the expanded graphite particle is 500 ppm or higher and 2,000 ppm or lower.

2. The urethane foam molded body according to claim 1,
wherein the alkali metal ion includes a sodium ion.

3. The urethane foam molded body according to claim 1,
wherein the composite particle has a content of 5% by volume or more and 50% by volume or less in a case where a volume of the urethane foam molded body is 100% by volume.

4. The urethane foam molded body according to claim 1,
wherein the first insulating inorganic particle has a content of 5% by volume or more and 20% by volume or less in a case where a volume of the urethane foam molded body is 100% by volume.

5. The urethane foam molded body according to claim 1,
wherein the first insulating inorganic particle has a thermal conductivity coefficient of 5 W/m·K or higher.

6. The urethane foam molded body according to claim 1,
wherein the first insulating inorganic particle includes at least one selected from aluminum hydroxide, aluminum oxide, aluminum nitride, magnesium hydroxide, magnesium oxide, talc, calcium carbonate, clay, mica, and silica.

7. The urethane foam molded body according to claim 1,
wherein the composite particle includes a second insulating inorganic particle adhered to a surface of the thermally conductive particle by a binder.

8. The urethane foam molded body according to claim 7,
wherein the second insulating inorganic particle includes at least one selected from aluminum hydroxide, aluminum oxide, aluminum nitride, magnesium hydroxide, magnesium oxide, talc, calcium carbonate, clay, mica, and silica.
